(19) United States
(12) Patent Application Publication
(10) Pub. No.: US 2010/0071845 A1
(43) Pub. Date: Mar. 25, 2010

(54) METHOD FOR FORMING FIBER MATERIAL COMPONENT

(75) Inventor: CHUN-YUAN CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/343,495

(22) Filed: Dec. 24, 2008

(30) Foreign Application Priority Data
Sep. 25, 2008 (CN) 200810304660.3

(51) Int. Cl. B29C 65/02

(52) U.S. Cl. 156/277

(57) ABSTRACT

A method for forming a fiber material component, includes: providing a foil, which includes a printed layer having printed patterns or characters thereon; placing a plurality of carbon fibers arranged in a crisscrossed form; placing the foil and the crisscrossed carbon fibers into a hot-press die, and sticking the printed layer of the foil on the carbon fibers; closing the hot-press die to fuse the carbon fibers together and transfer printing the patterns or characters of the printed layer on the carbon fibers to form a carbon fiber material component; and cooling the hot-press die, and then removing the formed carbon fiber material component.

### BACKGROUND

1. Technical Field

The disclosure relates to a method for forming a fiber material component.

2. Description of Related Art

Carbon fiber is made of extremely thin fibers about 0.0002-0.0004 inches in diameter and composed mostly of carbon atoms. The carbon atoms are bonded together in microscopic crystals that are more or less aligned parallel to the long axis of the fiber. The crystal alignment makes the fiber incredibly strong for its size. Several thousands of carbon fibers are twisted together to form a yarn, which may be used by itself or woven into a fabric. A carbon fiber has many different weaving patterns and can be combined with a plastic resin and wound or molded to form composite material such as carbon fiber reinforced plastic (also referenced as carbon fiber) to provide a high strength-to-weight ratio material. The density of the carbon fiber is also considerably lower than the density of steel, which makes the carbon fiber ideal for fabricating applications because of its light weight. The properties of the carbon fiber such as high tensile strength, light weight, and low thermal expansion make it very popular in aerospace, civil engineering, military, motorsports, electronic device enclosures, and so on.

However, it is difficult to paint different patterns or characters on carbon fiber materials, and consequently, the electronic device enclosures made from carbon fiber are plain and unattractive.

The present disclosure provides a method to obviate the described limitations.

### BRIEF DESCRIPTION OF THE DRAWINGS

FIG. 1 is a flowchart of an embodiment of a method for forming a fiber material component.

FIG. 2 is a flowchart of another embodiment of a method for forming a fiber material component.

### DETAILED DESCRIPTION

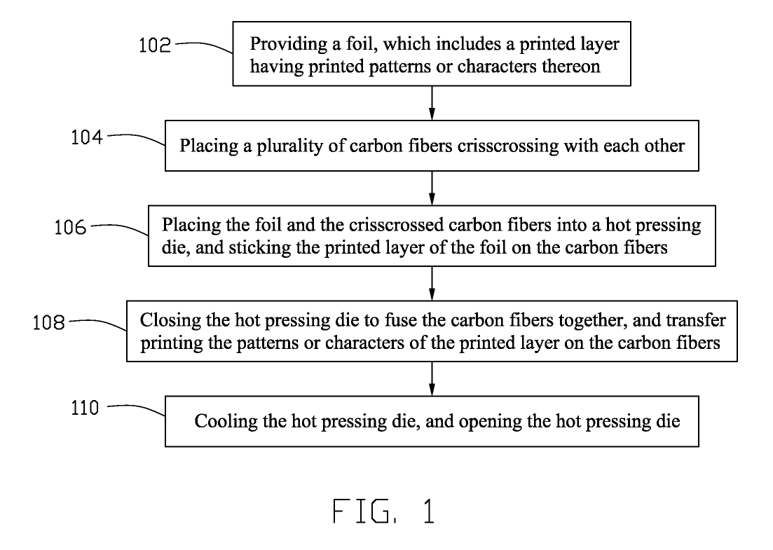

Referring to FIG. 1, an embodiment of a method is utilized to form a carbon fiber material component decorated with patterns or characters. The method includes the following steps:
Step 102, providing a foil which includes a base layer, and a printed layer attached to the base layer and having printed patterns or characters thereon; the printed layer is formed on the base layer in such a manner that some color ink, transparent ink, or decorative metal is applied on the base layer by means of vacuum plating, vacuum evaporation, and so on;
Step 104, providing a plurality of carbon fibers arranged in a crisscrossed form; the quantity of the carbon fibers is decided according to designed thickness of the carbon fiber material component to be formed;
Step 106, placing the foil and the crisscrossed carbon fibers into a hot-press die, and with the printed layer of the foil contacting the carbon fibers;
Step 108, closing the hot-press die to fuse the carbon fibers together and transfer printing the patterns or characters of the printed layer onto the carbon fibers to form a carbon fiber material component; and
Step 110: cooling the hot-press die and then opening the hot-press die to remove the formed component, which is now decorated with the patterns and characters.

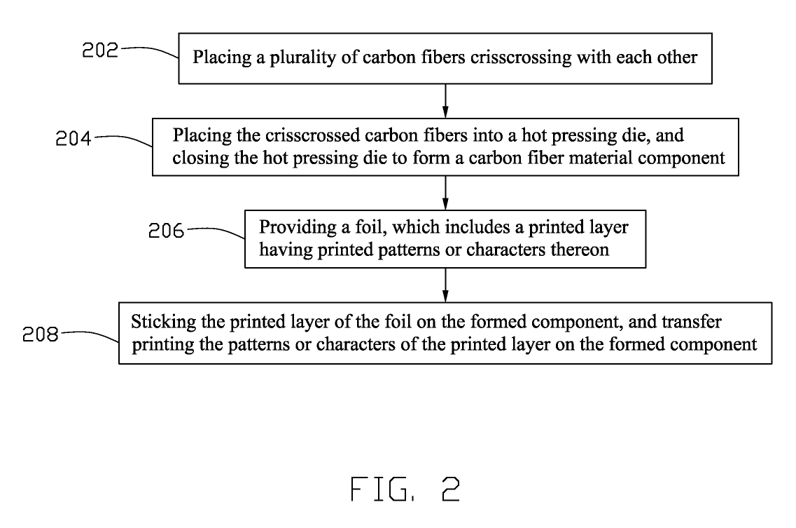

Referring to FIG. 2, another embodiment of a method for forming carbon fiber material component having different patterns or characters thereon, includes the following steps:
Step 202, providing a plurality of carbon fibers arranged in a staggered form; the quantity of the carbon fibers is decided according to designed thickness of the formed carbon fiber material component;
Step 204, placing the staggered carbon fibers into a hot-press die; and closing the hot-press die to form a carbon fiber material component;
Step 206, providing a foil, which includes a base layer, and a printed layer attached to the base layer with printed patterns or characters; the printed layer is formed on the base layer in such a manner that some color ink, transparent ink, or decorative metal is applied to the base layer by means of vacuum plating, vacuum evaporation, and so on; and
Step 208, place the foil onto the formed component with the printed layer in contact with the formed component, and transfer printing the patterns or characters of the printed layer on the formed component by use of some heat producing apparatus, such as an iron.

The method of the disclosure can be used to form enclosures of different notebook computers, mobile phones, and so on, which have different patterns and characters thereon.

The method also can use glass fibers to form a fiberglass material component, or other similar fibers.

While several embodiments have been disclosed, it is understood that any element disclosed in any one embodiment is easily adapted to other embodiments. It is also to be understood, however, that even though numerous characteristics and advantages of the disclosure have been set forth in the foregoing description, together with details of the structure and function of the invention, the disclosure is illustrative only, and changes may be made in details, especially in matters of shape, size, and arrangement of parts within the principles of the invention to the full extent indicated by the broad general meaning of the terms in which the appended claims are expressed.

What is claimed is:

1. A method for forming a fiber material component, comprising:
providing a foil which comprises a printed layer having printed patterns or characters thereon;
providing a plurality of carbon fibers arranged in a crisscrossed form;
placing the foil and the staggered carbon fibers into a hot-press die, and sticking the printed layer of the foil on the carbon fibers;
closing the hot-press die to fuse the carbon fibers together and transfer printing the patterns or characters of the printed layer onto the carbon fibers to form a carbon fiber material component; and
cooling the hot-press die, and then removing the formed carbon fiber material component.

2. The method of claim 1, wherein the foil further comprises a base layer, the printed layer is formed on the base layer in such a manner that some color ink, transparent ink, or metal decoration is stuck on the base layer.

3. A method for forming a fiber material component, comprising:
providing a plurality of carbon fibers arranged in a crisscrossed form;
placing the crisscrossed carbon fibers into a hot-press die, and fusing the carbon fibers to form a carbon fiber material component;
providing a foil, which comprises a printed layer having printed patterns or characters thereon; and
placing the printed layer of the foil on the formed component, and transfer printing the patterns or characters of the printed layer on the formed component.

4. The method of claim 3, wherein the foil further comprises a base layer, the printed layer is formed on the base layer in such a manner that some color ink, transparent ink, or metal decoration is stuck on the base layer.
